(19) United States
(12) Patent Application Publication
(10) Pub. No.: US 2025/0304026 A1
(43) Pub. Date: Oct. 2, 2025

(54) MANUAL UNLOCKING DEVICE FOR ELECTRONIC BRAKE

(71) Applicant: Xiamen Dalle New Energy Automobile Co.,Ltd, Xiamen City (CN)

(72) Inventor: Side Dai, Xiamen City (CN)

(21) Appl. No.: 18/659,432

(22) Filed: May 9, 2024

(30) Foreign Application Priority Data
Mar. 29, 2024 (CN) 202420638166.5

(51) Int. Cl. B60T 17/18; B60T 13/74

(52) U.S. Cl. CPC B60T 17/18; B60T 13/741

(57) ABSTRACT

A manual unlocking device for an electronic brake, including a motor, a brake pad, a brake disc, and an unlocking mechanism. The brake pad and the brake disc are arranged on the motor. The unlocking mechanism includes a toggle, a brake line, and a handle. The toggle is arranged on the brake disc and fixedly connected to the brake pad; an end of the brake line is fixedly connected to the toggle, and the other end of the brake line is fixedly connected to the handle. The handle is configured to adjust a stretching length of the brake line for switching a mating state between the brake pad and the brake disc.

### CROSS REFERENCE

The present disclosure claims priority of Chinese Patent Application No. 202420638166.5, filed on Mar. 29, 2024, the entire contents of which are hereby incorporated by reference in their entirety.

### TECHNICAL FIELD

The present disclosure relates to the technical field of electric vehicles, and more specifically to a manual unlocking device for an electronic brake.

### BACKGROUND

The electronic brake is a technology to realize parking brake by electronic control. Through an electromagnetic brake, the brake works when the power is on and will brake automatically when the power is off. In the process of a vehicle traveling, when the vehicle breaks down or the battery power is exhausted or there is a power cut off due to a mechanical failure, there will be a situation that the vehicle stops and is unmovable, where the vehicle' brake state cannot be manually released, such that the vehicle cannot be moved directly and has to be moved with the help of carrying tools or vehicles, which will cause trouble for maintenance. It can't be moved directly and needs to be moved with the help of carrying tools or vehicles, which will cause trouble for maintenance. In some cases, it is possible to unlock the brake by rotating a corresponding bolt through an external tool. However, it can be understood that different brake structures correspond to bolts of different models, which requires the replacement of different tools. In addition, the rotation operation upon the bolts is time-consuming and laborious.

### SUMMARY OF THE DISCLOSURE

The main purpose of the present disclosure is to provide a manual unlocking device for an electronic brake, in order to solve the above problems raised in the related art.

In order to realize the above purpose, the present disclosure provides the following technical solutions: a manual unlocking device for an electronic brake, including a motor, a brake pad, a brake disc, and an unlocking mechanism; wherein the brake pad and the brake disc are arranged on the motor; the unlocking mechanism includes a toggle, a brake line, and a handle; the toggle is arranged on the brake disc and fixedly connected to the brake pad; an end of the brake line is fixedly connected to the toggle, and the other end of the brake line is fixedly connected to the handle; the handle is configured to adjust a stretching length of the brake line for switching a mating state between the brake pad and the brake disc.

In some embodiments, the brake line is arranged with a fixing member for fixing the brake line; an adjusting space is defined between the fixing member and the toggle plate for adjusting the stretching length of the brake line.

In some embodiments, the brake line is screwed to the toggle through a first nut and screwed to the fixing member through a second nut.

In some embodiments, the fixing member is fixedly connected to the motor.

In some embodiments, the toggle is fixedly connected to the brake pad through a pin.

In some embodiments, the unlocking mechanism is configured to be arranged under a cushion of a low-speed electric vehicle.

In some embodiments, the handle is configured to be fixedly arranged on a vehicle body of a low-speed electric vehicle.

Compared to the related art, the beneficial effect of the present disclosure is that: in the present disclosure, a brake line is provided. Through the rotation of the handle to adjust the stretching length of the brake line and then switch the mating state between the brake pad and brake disc, the braking force between the brake disc and the brake pad can be released or applied, such that the electronic brake can be released and unlocked manually, ensuring that the vehicle can be moved in any case, which provides convenience to the vehicle to move and ensures the safety of the vehicle. In addition, the manual unlocking device is arranged under the cushion, whereby when the vehicle breaks down or the battery power is exhausted or there is a power cut off due to a mechanical failure, the electronic brake can be released and unlocked manually by turning over the seat, which is convenient for the movement of the vehicle.

### BRIEF DESCRIPTION OF THE DRAWINGS

FIG. 1 is a structural schematic view of a low-speed electric vehicle according to some embodiments of the present disclosure.

FIG. 2 is a structural schematic view of a manual unlocking device for an electronic brake according to some embodiments of the present disclosure.

FIG. 3 is an inner structural schematic view of a manual unlocking device for an electronic brake according to some embodiments of the present disclosure.

In the drawings: 100—vehicle body, 200—manual unlocking device for electronic brake, 1—motor, 2—brake pad, 3—brake disc, 5—unlocking mechanism, 51—toggle, 52—brake line, 53—handle, 54—pin, 55—fixing member, 56—first nut, 57—second nut.

### DETAILED DESCRIPTION

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure and not all of the embodiments. Based on the embodiments in the present disclosure, all other embodiments obtained by those skilled in the art without making creative labor fall within the scope of the present disclosure.

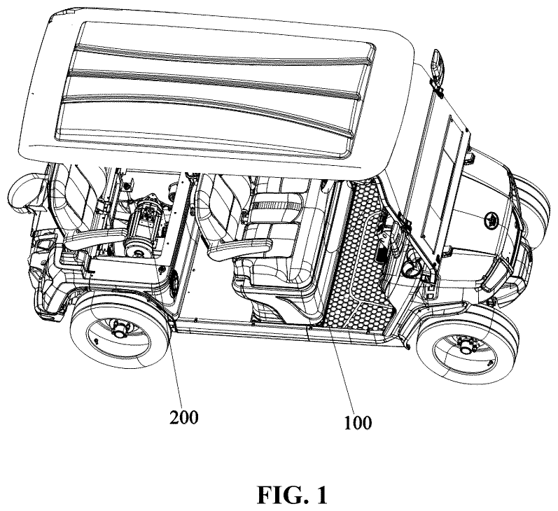

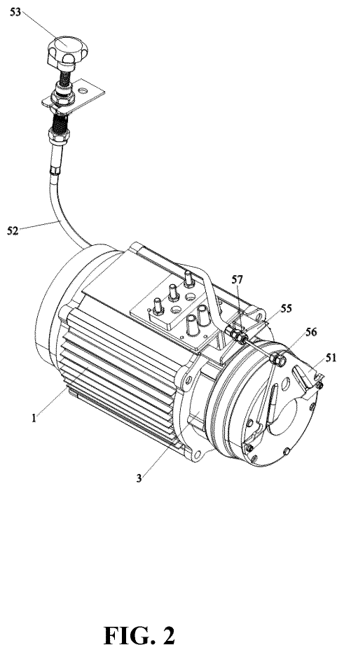

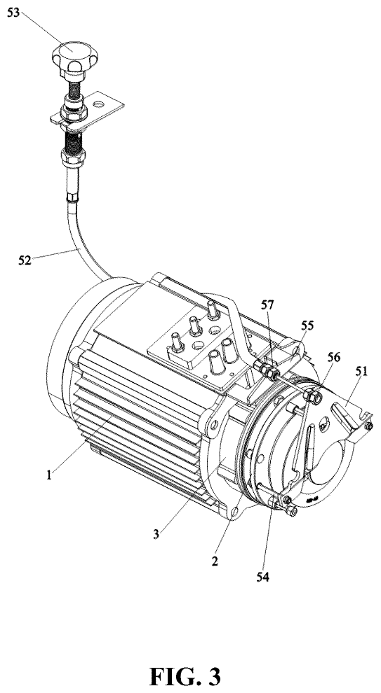

As shown in FIGS. 1 to 3, the present embodiments provide a low-speed electric vehicle, and the low-speed electric vehicle includes one or more of a sightseeing car, a golf cart, a fire truck, and a patrol car. The low-speed electric vehicle includes a vehicle body 100, and the vehicle body 100 is arranged with a cushion, where the cushion is detachably connected to the body 100; the low-speed electric vehicle further includes a manual unlocking device 200 for an electronic brake, and the manual unlocking device 200 is arranged under the cushion.

The manual unlocking device includes a motor 1, a brake pad 2, a brake disc 3, an electromagnetic brake, and an unlocking mechanism 5; the brake pad 2 and the brake disc 3 are arranged on the motor 1; an output end of the motor 1 is sleeved with a rotor; when the vehicle is moving, the brake disc 3 and the brake pad 2 are separated, and the rotor can be free to rotate; when the vehicle is in braking condition, the brake disc 3 compresses the rotor to fit on the brake pad 2, and fixes the output shaft of motor 1, which cannot rotate. The electromagnetic brake is adopted with a brake external half-wave rectifier to rectify single-phase alternating current into direct current, and its winding generates magnetic field after being energized, which attracts an armature back, in which case the armature compresses a spring fixed in the core. When the power is lost, the winding is discharged, and the spring pops the armature out, in which case the armature produces braking torque on the friction disc to make the motor stop. That is, the electromagnetic brake attracts brake disc 3 when being energized, in which case the motor 1 is allowed to work; while when the power is lost, the brake disc 3 loses its attraction force and presses down on the rotor for braking.

The unlocking mechanism 5 includes a toggle 51, a brake line 52, and a handle 53; the handle 53 is fixedly arranged on the vehicle body; the toggle 51 is arranged on the brake disc 3 and fixedly connected to the brake pad 2, for example, through a pin 54; an end of the brake line 52 is fixedly connected to the toggle 51, and the other end of the brake line 52 is fixedly connected to the handle 53; the handle 53 is configured to adjust a stretching length of the brake line 52 for switching a mating state between the brake pad 2 and the brake disc 3; the brake line 52 is arranged with a fixing member 55 for fixing the brake line 52; an adjusting space is defined between the fixing member 55 and the toggle plate 51 for adjusting the stretching length of the brake line 52; the fixing member 55 is fixedly connected to the motor 1, and the fixing member 55 may be a metal plate made of metal material; the brake line 52 is screwed to an upper end of the toggle 51 through a first nut 56, and screwed to the fixing member 55 through a second nut 57.

Under a normal state of the vehicle, the electromagnetic brake attracts the brake disc 3 when it is energized, and the motor 1 works to drive wheels to rotate; and when the power is cut off, the brake disc 3 loses its attraction force and presses down on the rotor for braking. When the vehicle breaks down or the battery is exhausted or there is a power cut off due to a mechanical failure, the vehicle is required to be serviced and thus the brake is required to be released, in which case the seat is flipped open, the handle 53 is rotated, such that the brake line 52 is elongated and the upper end of the toggle 51 is pushed out, driving the brake pad 2 to be displaced, which causes the gap between the brake pad 2 and the brake disc 3 to increase for unlocking. In this way, the vehicle can be moved for maintenance. When the vehicle is repaired, the handle 53 is reversely rotated, and thus the brake line 52 is reset.

In the present disclosure, a brake line is provided. Through the rotation of the handle to adjust the stretching length of the brake line and then switch the mating state between the brake pad and brake disc, the braking force between the brake disc and the brake pad can be released or applied, such that the electronic brake can be released and unlocked manually, ensuring that the vehicle can be moved in any case, which provides convenience to the vehicle to move and ensures the safety of the vehicle. In addition, the manual unlocking device is arranged under the cushion, whereby when the vehicle breaks down or the battery power is exhausted or there is a power cut off due to a mechanical failure, the electronic brake can be released and unlocked manually by turning over the seat, which is convenient for the movement of the vehicle.

Although the present disclosure has been described in detail with reference to the foregoing embodiments, for those skilled in the art, it is still possible to make modifications to the technical solutions recorded in the foregoing embodiments, or make equivalent replacements for some of the technical features therein. Any modifications, equivalent replacements, improvements, etc. made within the spirit and principles of the present disclosure shall be included in the scope of the present disclosure.

What is claimed is:

1. A manual unlocking device for an electronic brake, comprising a motor, a brake pad, a brake disc, and an unlocking mechanism; wherein the brake pad and the brake disc are arranged on the motor; the unlocking mechanism comprises a toggle, a brake line, and a handle; the toggle is arranged on the brake disc and fixedly connected to the brake pad; an end of the brake line is fixedly connected to the toggle, and the other end of the brake line is fixedly connected to the handle; the handle is configured to adjust a stretching length of the brake line for switching a mating state between the brake pad and the brake disc.

2. The manual unlocking device according to claim 1, wherein the brake line is arranged with a fixing member for fixing the brake line; an adjusting space is defined between the fixing member and the toggle plate for adjusting the stretching length of the brake line.

3. The manual unlocking device according to claim 2, wherein the brake line is screwed to the toggle through a first nut and screwed to the fixing member through a second nut.

4. The manual unlocking device according to claim 2, wherein the fixing member is fixedly connected to the motor.

5. The manual unlocking device according to claim 1, wherein the toggle is fixedly connected to the brake pad through a pin.

6. The manual unlocking device according to claim 1, wherein the unlocking mechanism is configured to be arranged under a cushion of a low-speed electric vehicle.

7. The manual unlocking device according to claim 1, wherein the handle is configured to be fixedly arranged on a vehicle body of a low-speed electric vehicle.
